(19) United States
(12) Patent Application Publication
(10) Pub. No.: US 2010/0119677 A1
(43) Pub. Date: May 13, 2010

(54) SYSTEM AND METHOD FOR PROVIDING DESSERTS UTILIZING SPECIALTY SOFT SERVE INSERTS

(76) Inventor: ROBERT CHAY, Fontana, CA (US)

Correspondence Address: JAFARI LAW GROUP, P.C., 801 N. PARKCENTER DRIVE, SUITE 220, SANTA ANA, CA, 92705, US

(21) Appl. No.: 12/266,992

(22) Filed: Nov. 7, 2008

(51) Int. Cl. A23P 1/10; B28B 3/20

(52) U.S. Cl. 426/515; 425/87

(57) ABSTRACT

The invention is a system and method for providing desserts utilizing a specialty soft serve insert, said insert comprising a body with multiple openings configured in a manner so that a more desirable textured mixture is produced when soft serve products are dispensed into a serving container. Said configuration helps preserve and enhance the dessert's flavor and produces a desirable aesthetic presentation of said soft serve dessert. In one embodiment, a soft serve insert for serving desserts in accordance with the present invention, comprises an insert adapted to couple with a frozen dessert processor, wherein said insert further comprises a body with an inlet portion for receiving a frozen dessert dispensed from said frozen dessert processor, and an outlet portion for producing a predefined shape, wherein said outlet portion includes a plurality of openings for dispensing said frozen dessert from said body.

### TECHNICAL FIELD OF THE INVENTION

The present invention relates in general to a system and method for providing desserts utilizing specialty soft serve inserts for ice cream products including soft serve desserts, and more specifically, to a system and method of utilizing an insert comprising one or more openings configured in a manner so that one or more desirable shapes, for example a plurality of tubular shapes, are produced when dessert products are dispensed into a serving container, which enhances said dessert's flavor and produces a desirable aesthetic presentation of said soft serve dessert.

### COPYRIGHT & TRADEMARK NOTICE

A portion of the disclosure of this patent application may contain material that is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and shall not be construed as descriptive or to limit the scope of this invention to material associated only with such marks.

### BACKGROUND OF THE INVENTION

It is well known that soft serve (also called creemee or soft ice cream) is a frozen dessert that is dispensed from a machine instead of being served by hand, for example by using an ice cream scoop device. Soft serve is desirable because it is generally lower in milk-fat (3% to 6%) than ice cream (10% to 18%) and is produced at a temperature of about −4° C. compared to ice cream, which is stored at −15° C. A warmer temperature allows the taste buds to detect more flavors. Soft serve contains air introduced at the time of freezing by said machines.

These machines have been known for some time and have made it possible for the presently known method of filling up an ice cream cone directly from the machine, without having to use a scoop, to become common practice. Such machines dispense all kinds of frozen desserts including ice cream, yogurt-based ice cream desserts, and soft serve desserts.

Part of the previously undesirable effects of older methods of providing ice cream or ice cream-like desserts was that often ice cream would crystallize. All ice cream including soft serve must be frozen quickly to avoid crystallization. With soft serve, this is accomplished by a special machine. A pre-mixed product is introduced to the storage chamber of the machine where it is kept at low temperatures (i.e. typically around +3° C.). When product is drawn from the draw valve, fresh mix is introduced to the freezing chamber either by gravity or pump. It is then agitated vigorously, quick frozen and stored until required.

The air content, called overrun, can vary from 0% to up to 60% of the total volume of the finished product. The amount of air alters the taste of the dessert. For example, soft serve products with low quantities of air are typically heavy, and taste icy, which is often undesirable and is less aesthetically appealing. Soft serve products with higher air content typically tastes creamier, smoother and are lighter, which is often desirable and is more aesthetically pleasing. The optimum quantity of air is determined by the other ingredients and individual taste. It is well known that there is an ideal range for the air content volume in the mixture. Producing an air content volume higher than said range causes the product to lose its taste since the mixture loses air and melts more quickly than that with less air.

Although it is understood in the art that the right combination of air and temperature is as important to the taste of the finished product as the other ingredients, presently known methods focus on providing said desired effects at the dessert generating or production stage of the process of making said ice cream or soft serve products (i.e. the ice cream or soft serve machines). The prior art does not focus on the final stage of the overall process, or the stage wherein said dessert products are presented to consumers for consumption. Thus, there are several problems with such presently existing methods of providing ice cream products such as soft serve desserts.

One problem is that once the dessert is provided to a consumer the dessert's consistency is often diminished upon serving on a cup, cone or a plate. This is because the dessert often comes out in a single (typically) tubular shape, which is then mashed together into a single semi-solid mixture. This often causes the dessert to maintain an undesirable shape and a loss of consistency is often experienced throughout the consumption process. This is partially due to the clumping up or solidifying effect that is caused by temperature and gravity puling down on the soft dessert (whether soft serve or ice cream).

Similarly, another related problem is that said tubular shape that clumps up and diminishes the texture within the served dessert. For example, the ice cream at the bottom of an ice cream cone, as is mashed together due to gravity, and perhaps higher temperatures, eventually clumps up thereby diminishing the air volume at the bottom of said ice cream cone. This causes the dessert to lose a desired consistency and taste that perhaps was achieved at the production process (i.e. in the machine) but not preserved when served for consumption.

Yet another related problem is that known methods for dispensing ice cream or soft serve desserts, do not adequately address the aesthetics of the dessert upon serving for consumption. Naturally, it is well known that dessert chefs have created their own ice cream dessert and have decorated said desserts in aesthetically pleasing compositions, however, said methods are relatively complicated for the average consumer without the know how, are time consuming, and often very costly.

Therefore, there is a need in the art for a system and method of providing desserts, for example soft serve desserts; which provides for a preserved consistency of said desserts for a period of time after dispensing said desserts from their generating (or ice cream making) machines upon serving for consumption; which provide a product that substantially maintains a desired shape upon being served on a container; and which provides an aesthetically pleasing presentation of such desserts in a manner that is simple, efficient, and easy to implement so that the practice is inexpensive.

The present invention overcomes the problems described above in a manner not taught or suggested by the prior art, and it is to these ends that the present invention has been developed.

### SUMMARY OF THE INVENTION

To minimize the limitations in the prior art, and to minimize other limitations that will be apparent upon reading and understanding the present specification, the present invention describes a system and method for providing desserts utilizing a specialty soft serve insert, said insert comprising a body with multiple openings configured in a manner so that a more desirable frozen dessert configuration is produced when soft serve products are dispensed into a serving container. Said configuration helps enhance the dessert's flavor and produces a desirable aesthetic presentation of said soft serve dessert, thereby uniquely increasing or elevating a consumer's experience.

A system for serving desserts, in accordance with the present invention, comprises a frozen dessert processor for processing and dispensing a frozen dessert; and an insert removably coupled to said frozen dessert processor, wherein said insert further comprises a body with an inlet portion for receiving a frozen dessert dispensed from said frozen dessert processor, and an outlet portion for producing a predefined shape, wherein said outlet portion includes a plurality of openings for dispensing said frozen dessert from said body.

A soft serve insert for serving desserts in accordance with the present invention, comprises an insert adapted to couple with a frozen dessert processor, wherein said insert further comprises a body with an inlet portion for receiving a frozen dessert dispensed from said frozen dessert processor, and an outlet portion for producing a predefined shape, wherein said outlet portion includes a plurality of openings for dispensing said frozen dessert from said body.

Another soft serve insert for serving desserts in accordance with the present invention, comprises an insert adapted to couple with a frozen dessert processor or machine, wherein said insert further comprises a circularly shaped body with an inlet portion for receiving a frozen dessert dispensed from said frozen dessert processor, and an outlet portion for producing a predefined shape, wherein said outlet portion includes a single substantially rectangular shaped opening for dispensing said frozen dessert from said body.

A method for serving desserts dispensed from a soft serve processor, comprising the steps of coupling an insert to a soft serve processor for dispensing soft serve desserts; wherein said insert further comprises a body with an inlet portion for receiving a frozen dessert dispensed from said frozen dessert processor, and an outlet portion for producing a predefined shape, wherein said outlet portion includes a plurality of openings for dispensing said frozen dessert from said body; actuating said soft serve processor; and collecting said soft serve dessert in a container for consumption.

It is an objective of the present invention to provide for an enhanced experience for consumers dining on soft serve desserts.

It is another objective of the present invention to provide a product with an improved texture and aesthetic appearance so as to enhance a consumer's experience.

Finally, it is yet another objective of the present invention to provide an aesthetically pleasing presentation of soft serve desserts in a manner that is simple, efficient, and easy to implement so that the practice is inexpensive.

These and other advantages and features of the present invention are described herein with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1 illustrates an ice cream dispenser commonly used today, including an insert for dispensing ice cream desserts in a single non-tubular shape.

FIG. 2(a) illustrates a dispenser and insert combination in accordance with one embodiment of the present invention, wherein the dispenser and insert form part of a single component adaptable or connected to a dessert generating machine.

FIG. 2(b) illustrates another embodiment in accordance with the present invention, wherein the cap or insert may be removably coupled to a dispenser or directly to a dessert generating machine.

FIG. 2(c) illustrates yet another embodiment in accordance with the present invention, wherein the cap or insert may be removably coupled to a dispenser or directly to a dessert generating machine, said insert containing multiple openings at one end of the dessert dispensing insert or cap.

FIG. 3(a) illustrates a specialized insert adapted for use with dispensers or directly with soft serve processing and dispensing machines, in accordance with an exemplary embodiment of the present invention.

FIG. 3(b) illustrates a top view of the dispenser depicted and disclosed with reference to FIG. 3(a).

FIG. 3(c) illustrates a specialized insert adapted for use with dispensers or directly with soft serve processing and dispensing machines, in accordance with another exemplary embodiment of the present invention.

FIG. 3(d) illustrates a top view of the dispenser depicted and disclosed with reference to FIG. 3(c).

FIG. 4(a) illustrates a top view of an embodiment of the present invention similar to the insert shown in FIG. 3(c), particularly depicting specifications or dimensions for openings configured to create a more desirable texture and shape when served into a container, which enhances the dessert's flavor and produces a desirable aesthetic presentation of the soft serve dessert, thereby creating a unique eating experience.

FIG. 4(b) illustrates a top view of yet another embodiment of the present invention similar to the insert shown in FIG. 4(a), particularly depicting specifications or dimensions for openings configured to create a more desirable texture and shape when served into a container, and further comprising an additional support member for aiding in coupling or removing said insert to and from a soft serve dispenser.

FIG. 5(a) illustrates a top view of yet another embodiment of the present invention similar to the insert shown in FIG. 3(a), particularly depicting specifications or dimensions for openings configured to create a more desirable texture and shape when served into a container, and further comprising an additional opening and support member.

FIG. 5(b) illustrates a top view of yet another embodiment of the present invention similar to the insert shown in FIG. 5(a), particularly depicting specifications or dimensions for openings configured to create a more desirable texture and shape when served into a container, and further comprising an additional support member for aiding in coupling or removing said insert to and from a soft serve dispenser.

FIG. 6(a) illustrates yet another embodiment of the present invention wherein a specialized single opening is centered in the body of the insert or cap to form a flat noodle shape when the soft serve dessert is dispensed.

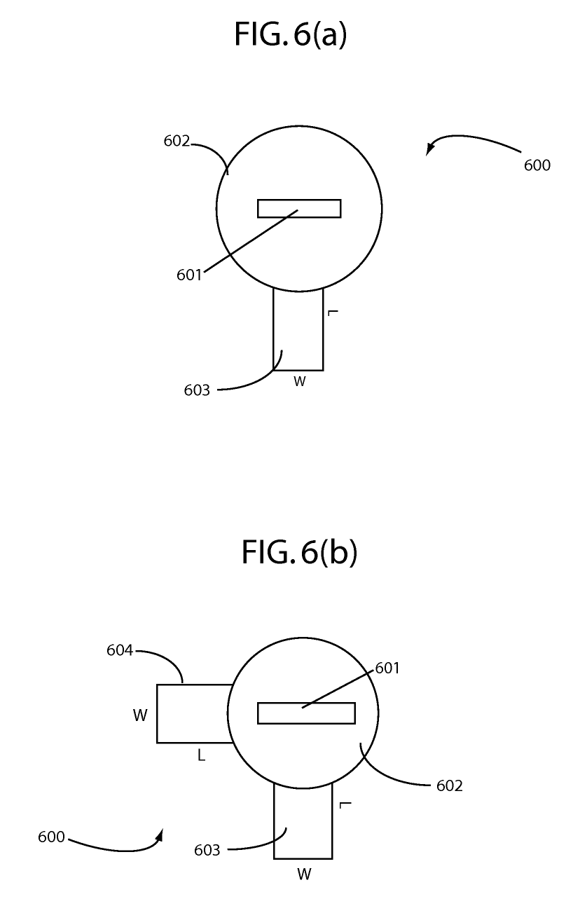

Finally, FIG. 6(b) illustrates yet another embodiment of the present invention wherein a specialized single opening is centered in the body of the insert or cap to form a flat noodle shape when the soft serve dessert is dispensed, wherein said insert or cap further comprises an additional support member to aid in the removal or insertion of said cap from and/or into a soft serve dispenser.

### DETAILED DESCRIPTION OF THE DRAWINGS

In the following discussion that addresses a number of embodiments and applications of the present invention, reference is made to the accompanying drawings that form a part hereof, where depictions are made, by way of illustration, of specific embodiments in which the invention may be practiced. It is to be understood that other embodiments may be utilized and changes may be made without departing from the scope of the present invention.

It is to be understood that in the present invention, the term dessert may include ice cream, ice cream like desserts such as yogurt based desserts, frozen desserts, soft serve desserts, or any other type of dessert commonly referred to as ice cream or soft serve desserts, without limiting the scope of the present invention.

Furthermore, the term inserts can be parts removably coupled to an ice cream dispensing machine, parts directly coupled, connected to, or attached to ice cream dessert dispensing machines, or can also be caps for dispensing apparatuses commonly used with said dispensing machines.

Further still, the term dispensing machine can be an ice cream maker, a soft serve maker, or any other type of dessert generating machine designed to generate, mix or otherwise produce a product for dispensing an ice cream dessert, without limiting the scope of the present invention.

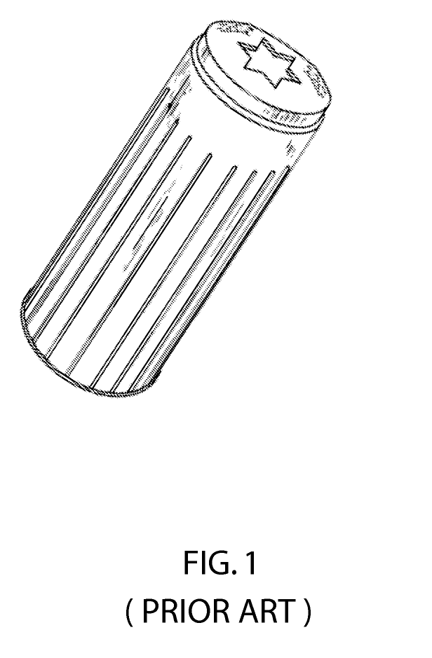

Turning to the first figure, FIG. 1 illustrates an ice cream dispenser commonly used today, including an insert for dispensing ice cream desserts in a single semi-tubular shape. Specifically, FIG. 1 shows that the prior art has provided some type of decorative openings at the end of dispensers, however, said openings (i.e. a single semi-tubular shape) do not solve the problem of properly maintaining the consistency and aesthetically pleasing structure of the dessert being dispensed.

Through some testing and development, it has been found that other configurations provide not only a better, more aesthetically pleasing dessert serving, but also allow for an improved presentation and therefore improved experience for a consumer when such desserts are finally served and presented for consumption.

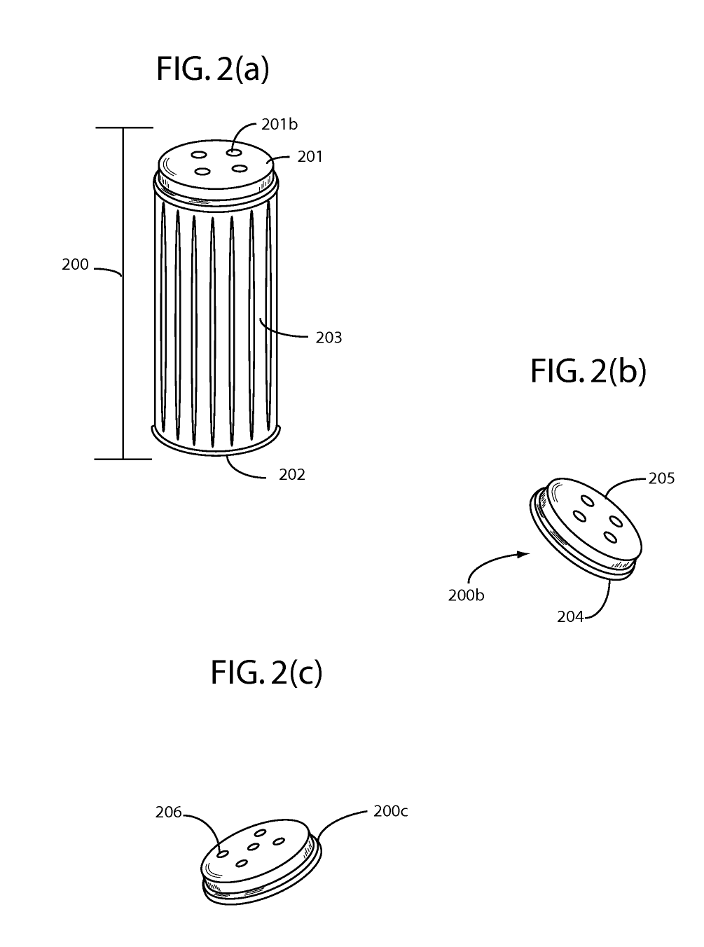

For example, turning to the following figure, FIG. 2(a) illustrates a dispenser and insert combination in accordance with one embodiment of the present invention, wherein the dispenser and insert form part of a single component adaptable or connected to a dessert generating machine.

More specifically, FIG. 2(a) shows dispenser 200 comprising of an outlet portion 201 configured with multiple openings 201b for dispensing a dessert into noodle shaped segments. This configuration for a dispensed dissert provides an improved texture and shape, which enhances a consumer's experience at the serving stage of the process of providing desserts to consumers.

Dispenser 200 may be made of metal, plastic, or any other type of material that can be used for dispensing desserts and that are safe and in accordance with proper health standards.

Dispenser 200 further comprises an inlet portion 202 configured with a single opening (i.e. inlet portion 202 of cylindrical member 203 is an open end of cylindrical member 203), configured to receive a dessert portion from a dispensing or frozen dessert generating processor or machine.

FIG. 2(b) illustrates another embodiment in accordance with the present invention, wherein the cap or insert may be removably coupled to a dispenser or directly to a frozen dessert generating processor or machine. More specifically, FIG. 2(b) shows insert 200b comprising of a first end 204 for receiving an ice cream dessert generated by a machine (not shown) and a second end 205 configured with multiple openings in a manner so that said openings evenly distribute the dessert into a serving container in a manner so as to form several tubular noodle-like shapes.

FIG. 2(c) illustrates yet another embodiment in accordance with the present invention, wherein the cap or insert may be removably coupled to a dispenser or directly to a dessert generating machine, said insert containing multiple openings at one end of the frozen dessert dispensing insert or cap.

More specifically, FIG. 2(c) shows insert 200c comprising of multiple openings 206. The difference in this embodiment is the number of openings and the spacing of openings, which may be desirable to create alternative dessert configurations when serving, for example, a soft serve dessert to a consumer for consumption.

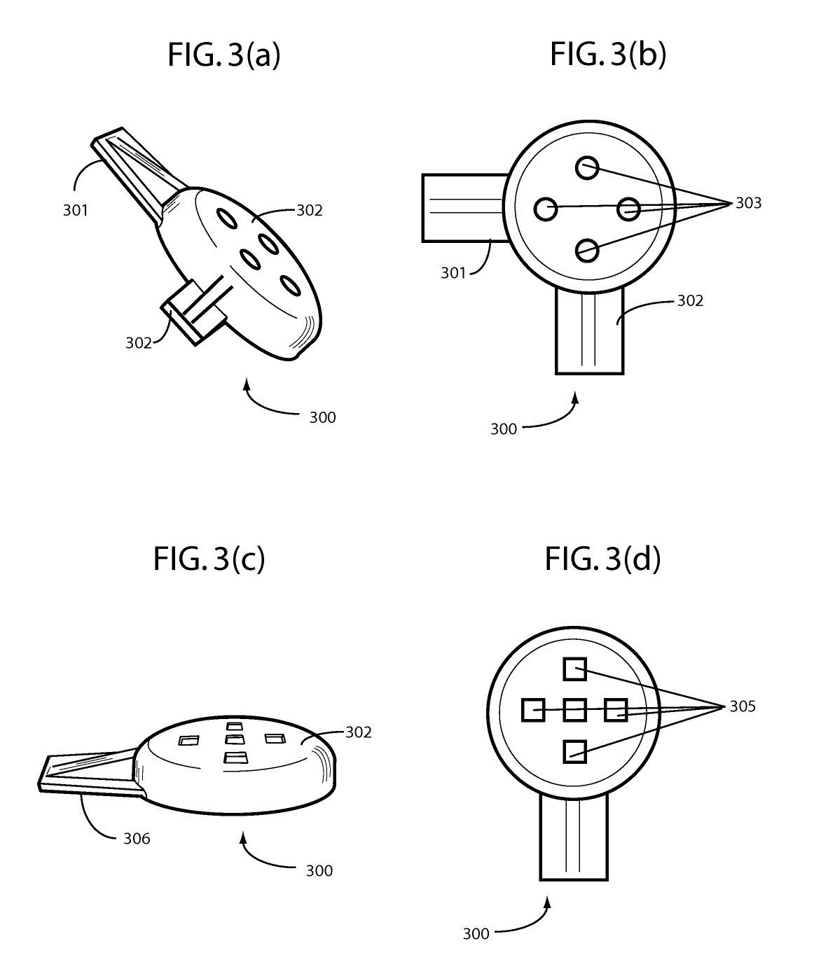

FIG. 3(a) illustrates a specialized insert adapted for use with dispensers or directly with soft serve processing and dispensing machines, in accordance with an exemplary embodiment of the present invention.

More specifically, FIG. 3(a) shows insert 300 comprising of a hollow body 302, a first handle 301 and a second handle 302 for coupling insert 300 into a dessert dispenser (not shown). Handles 301 and 302 are support members that allow a user to couple and later remove insert 300 for cleaning purposes, for example to maintain insert 300 in a sanitary condition, or to remove any former flavoring so as not to interfere with a second flavored dessert that may be served utilizing insert 300.

FIG. 3(b) illustrates a top view of the dispenser depicted and disclosed with reference to FIG. 3(a). More specifically, insert 300 can be seen from a top view comprising of openings 303, which are particularly shaped like circles. Naturally, other shapes may be implemented with insert 300, and such other alternative embodiments will be discussed in more detail below.

For example, and with out deviating from the scope of the present invention, openings 303 may be shaped substantially like squares, octagons, triangles, star-like shapes, or any other type of polygon shapes—as long as the resulting dispensing shapes created are formed so as to provide an aesthetically pleasing shape (e.g. multiple or more than one tubular, or elongated cubical shapes) that conserve the presence and desired consistency of the dessert once served for consumption and, which enhances the consumer's eating experience.

FIG. 3(c) illustrates a specialized insert adapted for use with dispensers or directly with soft serve processing and dispensing machines, in accordance with another exemplary embodiment of the present invention.

More specifically, FIG. 3(c) shows another exemplary embodiment of insert 300 also comprising of a hollow body 302, but including only a single handle 306. This may be desirable as a simpler less expensive product since fewer raw materials are needed. Furthermore, this embodiment of insert 300 further comprises of five squared openings 305 at a top end of insert 300 for dispensing desserts in elongated cubical shape formations for yet a different aesthetically pleasing way of serving, for example, soft serve desserts. Openings 305 are more clearly shown in FIG. 3(d).

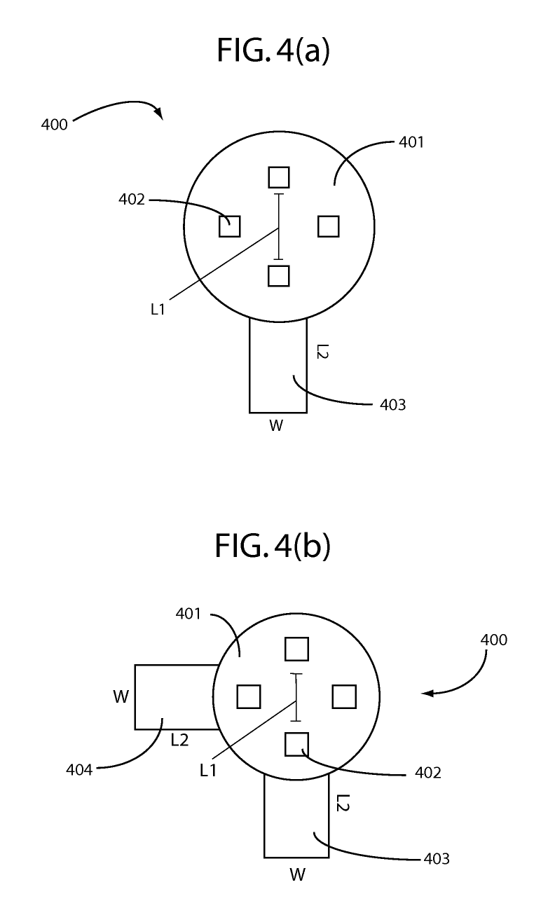

FIG. 4(a) illustrates a top view of an embodiment of the present invention similar to the insert shown in FIG. 3(c), particularly depicting specifications or dimensions for openings configured to create a more desirable texture and shape when served into a container, which preserves the dessert's flavor and produces a desirable aesthetic presentation of the soft serve dessert.

More specifically, FIG. 4(a) shows an exemplary embodiment in accordance with the present invention, showing insert 400 comprising of a hollow body 401 with squared openings 402 spaced apart at a distance or length L1. Hollow body 401 further comprises a support member or handle 403 with dimensions L (a second length) and W (a first width). It is to be understood that different sizes, dimensions or insert specifications may be adjusted to be adaptable for use with larger frozen dessert machines, smaller frozen dessert machines, or any size or type of frozen dessert machines presently used or used in accordance with practice of the present invention.

Although it is to be understood that several specifications or dimensions may be implemented without deviating from the scope of the present invention, in an exemplary embodiment, openings 402 may comprise 4.25 mm×4.25 mm and be spaced apart by a length L1 of 16.5 mm. In said exemplary embodiment, handle 403 may have a second length L2 of 19 mm and a first width W of 12 mm. In said exemplary embodiment, the insert's body 401 may have a diameter of 39 mm.

Although other dimensions may be possible without deviating from the scope of the present invention, these dimensions may be desirable as compatible with most currently existing ice cream or soft serve dispensing/generating machines in the market.

FIG. 4(b) illustrates a top view of yet another embodiment of the present invention similar to the insert shown in FIG. 4(a), particularly depicting specifications or dimensions for openings configured to create a more desirable texture when served into a container, and further comprising an additional support member for aiding in coupling or removing said insert to and from a soft serve dispenser. It is to be understood that different sizes, dimensions or insert specifications may be adjusted to be adaptable for use with larger frozen dessert machines, smaller frozen dessert machines, or any size or type of frozen dessert machines presently used or used in accordance with practice of the present invention.

As described above, the additional handle 404 may have a multitude of varying dimensions, but it may be desirable to have the same dimensions as that of handle 403 so as to make the design more uniform and thereby easier to implement with existing machines and easy to manufacture.

In such embodiment, different dimensions may too be implemented, for example and in no way limiting the scope of the present invention, openings 402 may comprise 4.25 mm×4.25 mm dimensions and be spaced apart by a distance or length L1 of 13.5 mm. In said exemplary embodiment, handle 403 and handle 404 may have a second length L2 of 14 mm and a first width W of 12 mm. In said exemplary embodiment, the insert's body 401 may have a diameter of 31 mm.

Again, although other dimensions may be possible without deviating from the scope of the present invention, these dimensions may be desirable so as to be compatible with most currently existing ice cream or soft serve dispensing/generating machines in the market.

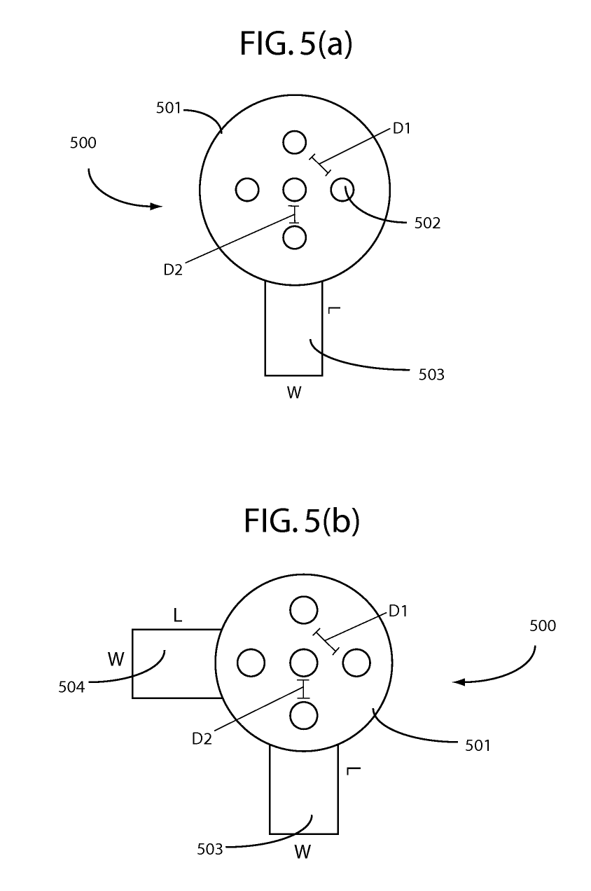

Turning to our next figure, FIG. 5(a) illustrates a top view of yet another embodiment of the present invention similar to the insert shown in FIG. 3(a), particularly depicting specifications or dimensions for openings configured to create a more desirable texture when served into a container.

More specifically, FIG. 5(a) shows an exemplary embodiment in accordance with the present invention, showing insert 500 comprising of a hollow body 501 with circular openings 502 spaced apart at distances D1 and D2. Hollow body 501 further comprises a support member or handle 503 with dimensions L (a first length) and W (a first width). It is to be understood that different sizes, dimensions or insert specifications may be adjusted to be adaptable for use with larger frozen dessert machines, smaller frozen dessert machines, or any size or type of frozen dessert machines presently used or used in accordance with practice of the present invention.

Although it is to be understood that several specifications or dimensions may be implemented without deviating from the scope of the present invention, in an exemplary embodiment, openings 502 may comprise a diameter of 4.75 mm and be spaced apart by a length or distance D1 of 9.25 mm and a distance D2 of 5.175 mm. In said exemplary embodiment, handle 503 may have a first length L of 19 mm and a first width W of 12 mm. In said exemplary embodiment, the insert's body 501 may have a diameter of 39 mm.

Although other dimensions may be possible without deviating from the scope of the present invention, these dimensions may be desirable as compatible with most currently existing ice cream or soft serve dispensing/generating machines in the market.

FIG. 5(b) illustrates a top view of yet another embodiment of the present invention similar to the insert shown in FIG. 5(a), particularly depicting specifications or dimensions for openings configured to create a more desirable texture when served into a container, and further comprising an additional support member or handle 504 for aiding in coupling or removing said insert to and from a soft serve dispenser.

In such embodiment, different dimensions may too be implemented, for example and in no way limiting the scope of the present invention, openings 502 may comprise a diameter of 4.75 mm and be spaced apart by a distance D1 of 6.36 mm and a distance D2 of 4.5 mm. In said exemplary embodiment, handle 503 and handle 504 may have a first length L of 14 mm and a first width W of 12 mm each. Furthermore, in said exemplary embodiment, the insert's body 501 may have a diameter of 31 mm.

Naturally, it is to be understood that different sizes, dimensions or insert specifications may be adjusted to be adaptable for use with larger frozen dessert machines, smaller frozen dessert machines, or any size or type of frozen dessert machines presently used or used in accordance with practice of the present invention.

Again, although other dimensions may be possible without deviating from the scope of the present invention, these exemplary dimensions may be desirable so as to be compatible with most currently existing ice cream or soft serve dispensing/generating processors/machines found in the market.

Finally, FIG. 6(a) illustrates yet another embodiment of the present invention wherein a specialized single opening is centered in the body of the insert or cap to form a flat noodle shape when the soft serve dessert is dispensed. FIG. 6(b) illustrates yet another embodiment of the present invention wherein a specialized single opening is centered in the body of the insert or cap to form a flat noodle shape when the soft serve dessert is dispensed, wherein said insert or cap further comprises an additional support member to aid in the removal or insertion of said cap from and/or into a soft serve dispenser.

More specifically, FIG. 6(a) shows soft serve insert 600 comprising of a body 602, which includes a single rectangular opening 601, centered in the top side of body 602. In the shown embodiment insert 600 comprises a single handle 603 with a length L and width W. Again, it is to be understood that different sizes, dimensions or insert specifications may be adjusted to be adaptable for use with larger frozen dessert machines, smaller frozen dessert machines, or any size or type of frozen dessert machines presently used or used in accordance with practice of the present invention.

In exemplary dimensions of said embodiment, opening 601 may be defined by a rectangular shape having a 20 mm length and a 4.25 mm width. Furthermore, handle 603 may have a length L of 19 mm and a width W of 12 mm. In said exemplary embodiment, the insert's body 602 may have a diameter of 39 mm.

Alternatively, FIG. 6(b) shows soft serve insert 600 comprising of a body 602, which includes a single rectangular opening 601, centered in the top side of body 602. In the shown embodiment insert 600 comprises handle 603 and handle 604, each with a similar length L and width W.

Opening 601 may be defined by a rectangular shape having a 20 mm length and a 4.25 mm width. Furthermore, handles 603 and handles 604 may each have a length L of 14 mm and a width W of 12 mm. In said exemplary embodiment, the insert's body 602 may have a diameter of 31 mm.

Again, although many dimensions may be possible without deviating from the scope of the present invention, the following dimensions may be desirable as compatible with most currently existing ice cream or soft serve dispensing/generating machines in the market.

The present invention solves the problems presented by the prior art by particularly producing a special texture and shape when dispensing frozen desserts into containers such as cones or dessert plates. While current practices use a single tubular shape that gets mashed and easily loses consistency, by implementing multiple or a plurality of smaller elongated shapes (for example and without deviating from the scope of the present invention, noodle like shapes, smaller polygonal noodle-like shapes, or a single, but flat noodle like shape) the layering process, as the frozen dessert is dispensed, tends to create an overall dessert configuration that enhances the texture and produces a unique desirable dinning experience.

A system and method for providing desserts utilizing specialty soft serve inserts has been described. The foregoing description of the various exemplary embodiments of the invention has been presented for the purposes of illustration and disclosure. It is not intended to be exhaustive or to limit the invention to the precise form disclosed. Many modifications and variations are possible in light of the above teaching. It is intended that the scope of the invention not be limited by this detailed description, but by the claims and the equivalents to the claims.

What is claimed is:

1. A system for serving desserts, comprising:
a frozen dessert processor for processing and dispensing a frozen dessert; and
an insert removably coupled to said frozen dessert processor, wherein said insert further comprises:
a body with an inlet portion for receiving a frozen dessert dispensed from said frozen dessert processor, and
an outlet portion for producing a predefined shape, wherein said outlet portion includes a plurality of openings for dispensing said frozen dessert from said body.

2. The system of claim 1, wherein said insert includes a dispenser unit

3. The system of claim 1, wherein said openings are arranged in a configuration comprising a plurality of substantially circle shaped openings.

4. The system of claim 1, wherein said openings are arranged in a configuration comprising a plurality of substantially square shaped openings.

5. The system of claim 1, wherein said openings are arranged in a configuration comprising a plurality of substantially stared shaped openings.

6. The system of claim 1, wherein said openings are arranged in a configuration comprising a plurality of openings shaped in a variety of polygonal shapes.

7. A soft serve insert for serving desserts, comprising:
an insert adapted to couple with a frozen dessert processor, wherein said insert further comprises:
a body with an inlet portion for receiving a frozen dessert dispensed from said frozen dessert processor, and
an outlet portion for producing a predefined shape, wherein said outlet portion includes a plurality of openings for dispensing said frozen dessert from said body.

8. The insert of claim 7, wherein said insert includes a dispenser unit

9. The insert of claim 7, wherein said openings are arranged in a configuration comprising a plurality of substantially circle shaped openings.

10. The insert of claim 7, wherein said openings are arranged in a configuration comprising a plurality of substantially square shaped openings.

11. The insert of claim 7, wherein said openings are arranged in a configuration comprising a plurality of substantially stared shaped openings.

12. The insert of claim 7, wherein said openings are arranged in a configuration comprising a plurality of openings shaped in a variety of polygonal shapes.

13. A method for serving desserts dispensed from a soft serve processor, comprising the steps of:
coupling an insert to a soft serve processor for dispensing soft serve desserts, wherein said insert further comprises:
a body with a first end, said first end including an opening for receiving a frozen dessert dispensed from said frozen dessert processor, and
a second end oppositely situated from said first end, wherein said second end further comprises one or more openings for dispensing said frozen dessert from said body;
actuating said soft serve processor; and
collecting said soft serve dessert in a container for consumption.

14. The method of claim 13, wherein said method includes a dispenser unit

15. The method of claim 13, wherein said openings are arranged in a configuration comprising a plurality of substantially circle shaped openings.

16. The method of claim 13, wherein said openings are arranged in a configuration comprising a plurality of substantially square shaped openings.

17. The method of claim 13, wherein said openings are arranged in a configuration comprising a plurality of openings shaped in a variety of polygonal shapes.

18. The method of claim 13, wherein said openings are arranged in a configuration comprising a plurality of substantially stared shaped openings.

19. A soft serve insert for serving desserts, comprising:
an insert adapted to couple with a frozen dessert processor, wherein said insert further comprises:
a circularly shaped body with an inlet portion for receiving a frozen dessert dispensed from said frozen dessert processor, and
an outlet portion for producing a predefined shape, wherein said outlet portion includes a single substantially rectangular shaped opening for dispensing said frozen dessert from said body.

20. The insert of claim 19, wherein said substantially rectangular shaped opening is centrally situated on said outlet portion of said body.
